(19) United States
(12) Patent Application Publication
(10) Pub. No.: US 2019/0037880 A1
(43) Pub. Date: Feb. 7, 2019

(54) Sunflower, Flax, Camelina or Hemp Meal-Based Tofu-Like Product

(71) Applicants: Darcelle Julie Graham, Roland (CA); James Duncan House, Winnipeg (CA); Lee Anne Murphy, Winnipeg (CA)

(72) Inventors: Darcelle Julie Graham, Roland (CA); James Duncan House, Winnipeg (CA); Lee Anne Murphy, Winnipeg (CA)

(21) Appl. No.: 16/053,131

(22) Filed: Aug. 2, 2018

Related U.S. Application Data
(60) Provisional application No. 62/540,863, filed on Aug. 3, 2017.

(30) Foreign Application Priority Data
Oct. 3, 2017 (CA) 2981319

(51) Int. Cl. A23J 3/14; A23J 1/00

(52) U.S. Cl. CPC A23J 3/14; A23J 1/006

(57) ABSTRACT

Described is a method for the preparation of protein rich milk and a tofu-like product from decupled sunflower, flax, camelina or hemp meal that is, sunflower, flax, camelina or hemp milk and a coagulated product from a cold pressed sunflower, flax, and camelina or hemp meal. Sunflower, flax, camelina and hemp meal, a by-product of sunflower, flax, camelina and hemp oil processing is typically used as a feed ingredient for livestock animals.

### FIELD OF THE INVENTION

The present disclosure relates to processes to produce protein milk and tofu like foods from oilseeds, and the milk and foods so produced.

### BACKGROUND OF THE INVENTION

The global protein ingredients market represents a multi-billion dollar industry, dominated by dairy-based ingredients, egg, gelatin, and soy-based and wheat-based proteins. Food processors are shifting towards lower cost plant-based proteins due to rising costs of animal-based ingredients and growing demand for vegetable proteins. They are also seeking alternatives to soy and wheat proteins because of allergy and gluten concerns. Despite the increased demand for plant based proteins, their widespread use has been hindered by reduced solubility and functionality relative to animal-based proteins and strong flavors associated with some plant proteins.

Tofu is a highly nutritious, protein-rich food that is made from the curds of soybean milk. Basic regular tofu is a white, essentially bland, soft product. Its production starts with a soybean soaking process to prepare the soybeans for extraction of soy protein. Whole, dry soybeans are saturated with water at ambient temperature for 10-14 hours although soybean flakes or “grits” can also be used. The soaked beans or flakes are ground to the desired particulate size. The ground soybean slurry is then cooked, typically with direct or indirect heat or steam up to 100 to 110° C. for 3 to 10 minutes. During the cooking process, soy protein is denatured and some of the volatile flavors are removed. The resultant soy slurry may be filtered to remove the soy pulp or fiber or the slurry may be filtered prior to cooking. The resulting product, referred to as soymilk, is then coagulated to form curds and whey. Whey is removed before or during pressing of the curds. The finished, pressed curds are referred to as tofu.

Tofu is made in a number of varieties, which are generally related to the firmness or texture of the tofu. For example, in addition to fresh tofu, there is soft or silken tofu (which has high moisture content), firm tofu (which has a texture similar to firm custard) and extra firm tofu (in which the majority of the liquid has been removed). Tofu-like products have been made from a variety of non-soybean sources, for example, egg tofu, sesame tofu, peanut tofu and Burmese tofu (which uses yellow split pea flour and is set in a manner similar to soft polenta).

Protein rich meals, the by-products of sunflower, flax, camelina and hemp processing for oil extraction, are high in protein and typically used as a feed ingredient for livestock animals. Utilization of sunflower, flax, camelina or hemp meal for something other than animal feed has been investigated for a number of years; the emphasis has been to isolate the protein or other fractions and use them for human consumption. The methodology for and concept of making a tofu like product from sunflower, flax, camelina or hemp meal (by-product following the removal of the oil from sunflower, flax, camelina and hemp) is new.

In previous work it was shown that high-oil press cakes prepared from canola can be used to prepare canola milk and subsequently canola tofu-like product (WO 2016/154734, sharing one of the present inventors, incorporated herein by reference).

### SUMMARY OF THE INVENTION

The present inventors have now taught the preparation of sunflower, flax, camelina or hemp milk, and a tofu-like coagulated product from sunflower, flax, camelina or hemp meal.

According to one aspect of the invention, there is provided a method of making tofu-like sunflower, flax, camelina or hemp meal food products comprising: grinding a quantity of sunflower, flax, camelina or hemp meal cake; passing the ground meal cake through a 0.5 mm sieve, thereby removing non-soluble fragments from the ground meal cake; soaking the ground meal cake in water for a period of time; filtering the soaked ground meal cake, thereby isolating a milk concentrate; heating the milk concentrate while agitating the milk concentrate to induce protein unfolding; adding a suitable coagulant to the heated milk concentrate; cooling the milk concentrate and coagulant mixture; draining the mixture, thereby producing curd; and pressing the curd into a tofu-like product.

Preferably, the ground meal cake is soaked for 6-24 hours, more preferably, for about 16 hours. Preferably, the ground meal cake and the water are mixed a ratio from 10:1 to 4:1, more preferably, at a ratio of about 5:1. Preferably, filtering is through a towel lined with cheesecloth.

The coagulant may be: calcium sulfate; magnesium chloride; magnesium sulfate (MgSO₄), calcium chloride; glucono delta-lactone (GDL); acetic acid; citric acid; papain; vinegar, an alkaline protease; a neutral protease; and mixtures thereof. The coagulant may be between 0.5% to 5.0% (v/v).

The grinding may be done by a hammer mill, a roller mill or a pin mill, preferably fine or medium grinding, more preferably fine grinding. The non-soluble fragments may be removed by sieving the ground meal cake, preferably using about a 500 μm to 1 mm sieve, more preferably a 0.5 mm sieve.

The milk concentrate may be heated to a temperature between 75-100° C., preferably about 90-95° C., more preferably about 75-90° C. The cooling may be performed at room temperate for about 10-60 minutes, then at −4° C. to 10° C. for about 1-12 hours, more preferably at room temperate for about 30 minutes, then at about 5° C. for about 1.5 hours.

The agitation may be gentle, for example, by submersible paddle mixer set at 20 rpm, or equivalent.

The invention also teaches a tofu like food product and a protein milk food product obtained by the methods described herein.

### DESCRIPTION OF PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

The phrase “non-soluble components” refers to the fraction of the ground sunflower, flax, camelina or hemp meal consisting of particles in excess of 0.5 mm, which cannot be redispersed in water or another solvent

Described herein is a method for the preparation of a tofu-like product from sunflower, flax, camelina or hemp meal.

Sunflower, flax, camelina or hemp meal, a by-product of sunflower, flax, camelina and hemp oil processing, are typically used as a feed ingredient for livestock animals.

As discussed herein, sunflower, flax, camelina or hemp meal have not previously been used for preparation of a tofu-like product because of several concerns regarding the nature of the sunflower, flax, camelina and hemp meal itself and the process of preparing tofu from soybean. Specifically, compared to soybean meal, sunflower, flax, camelina or hemp meal have lower protein content (27.9-35.7% for sunflower, flax, camelina or hemp meals compared to 48% crude protein for soybean meal), higher fat (17% for sunflower, flax, camelina or hemp meal compared to 1.0% fat for soybean meal) and much higher fiber content (10.5 to 27.9% crude fiber for cold press sunflower, flax, camelina or hemp meal compared to 3% crude fiber for soybean meal). Accordingly, as discussed below, there were concerns regarding the coagulation of the lower protein content sunflower, flax, camelina or hemp meal, as well as concerns regarding the difficulties in processing such a high oil, high fiber meal and the ability to form a suitable tofu cake from a meal having these characteristics. Specifically, overall, sunflower, flax, camelina and hemp meal proteins are more soluble than soy meal proteins, which, as will be appreciated by one of skill in the art, may cause difficulties during the preparation of a tofu-like product from sunflower, flax, camelina or hemp meal, specifically, during the coagulation of the sunflower, flax, camelina and hemp milk, as discussed herein.

Creating a tofu-like product made from the high fiber, low protein content, high protein solubility sunflower, flax, camelina or hemp meal, required additional considerations. Sunflower, flax, camelina or hemp meal cake has a darker and potentially gritty appearance, meaning that the meal cake might be expected to produce a product with an unappetizing appearance as well as a gritty mouth-feel. Furthermore, sunflower, flax, camelina or hemp meal also has a bitter taste, meaning that any tofu-like product produced therefrom might be unpalatable. Sunflower, flax, camelina or hemp meal contains glucosinolates, phenolics, and phytates, all of which are problematic for food use.

Sunflower, flax, camelina and hemp oil can be extracted by cold pressing. Cold pressing does not involve heating of the sunflower, flax, camelina and hemp seeds/meal before, during, or after the pressing process. Seeds are selected, cleaned, and rolled or crushed. Sunflower seeds may be dehulled. The seeds are then mechanically pressed at a slow speed to limit friction and avoid elevating temperatures above 60° C. The screw presses can be water cooled to ensure the temperature of the pressed cake does not exceed 60° C. during mechanical processing. The resulting meal is much higher in oil than the meal obtained from conventionally processed sunflower, flax, camelina and hemp.

The sunflower, flax, camelina or hemp meal cake used in the manufacture of the tofu-like product according to the present invention can be either a solvent-extracted de-hulled sunflower seed, flax, camelina and hemp meal cake or a cold press sunflower, flax, camelina and hemp meal cake, although in preferred embodiments, cold press dehulled sunflower, flax, camelina or hemp meal cake is used.

In an embodiment of the invention, there is provided a method of making a tofu-like sunflower, flax, camelina or hemp meal food product comprising: grinding a quantity of sunflower, flax, camelina or hemp meal cake; passing the ground sunflower, flax, camelina and hemp meal cake through a 0.5 mm sieve, thereby removing non-soluble fragments from the ground sunflower, flax, camelina or hemp meal cake;

soaking the ground meal cake in water for a period of time;
filtering the soaked ground meal cake, thereby isolating a sunflower, flax, camelina or hemp milk concentrate;
heating the sunflower, flax, camelina or hemp milk concentrate while agitating the sunflower, flax, camelina or hemp milk concentrate to induce protein unfolding;
adding a suitable coagulant to the heated sunflower, flax, camelina or hemp milk concentrate;
Cooling the sunflower, flax, camelina or hemp milk concentrate and coagulant mixture; draining the mixture, thereby producing sunflower, flax, camelina and hemp curd; and pressing the sunflower, flax, camelina and hemp curd into a tofu-like product.

The sunflower, flax, camelina and hemp curd may be placed into a mold prior to pressing so that the tofu-like product has the desired shape.

As discussed above, sunflower, flax, camelina or hemp meal contains anti-nutritive factors including glucosinolates, phenolics, and phytates, all of which are problematic for food use. However, the levels of these antinutrients in the final tofu-like product was surprisingly found to be greatly reduced compared to the sunflower, flax, camelina and hemp meal cake as a result of the sieving and heating steps.

The sunflower, flax, camelina or hemp meal cake may be ground by any suitable means known in the art, for example, a hammer mill, a roller mill or a pin mill. Preferably, the sunflower, flax, camelina or hemp meal cake is ground until the sunflower, flax, camelina or hemp meal cake is in the form of individual particles and does not contain any clumps. Alternatively, the sunflower, flax, camelina or hemp meal cake may be ground such that the non-soluble fragments will be retained by a 0.5 mm sieve (that is, will not pass through a 0.5 mm sieve).

In some embodiments, approximately 1-15% of the sunflower, flax, camelina or hemp meal cake is removed by the sieving process. This 1-15% is composed primarily of non-soluble fragments which are high in fibre.

The ground meal cake can be soaked for any suitable period of time, for example, for 6-24 hours, preferably 10-15 hours. Variations in soaking time have been used, ranging from 0 to 100 hours.

The ground meal cake and the water may be mixed at any suitable ratio, for example from 10:1 to 4:1. As will be appreciated by one of skill in the art, if too little water is added, some of the soluble material may fall out of solution and be lost during filtering. Alternatively, if too much water is added, the sunflower, flax, camelina or hemp milk may be too dilute to coagulate.

The filtering of the soaked ground meal cake is carried out so that only the soluble material passes through the filter and insoluble material such as non-soluble fragments are removed.

The sunflower, flax, camelina and hemp milk concentrate may be heated to a temperature between 75-100° C., for example, to a temperature between 90-95° C. for an appropriate time. Preferably, the temperature of the sunflower, flax, camelina or hemp milk is increased gradually so as to avoid excessive denaturation of the sunflower, flax, camelina and hemp proteins. Once the milk reaches the desired temperature, the milk is removed from heat prior to the addition of the coagulant, as discussed below.

The coagulant may be any suitable coagulant known for the production of tofu or similar products may be used in the invention. For example, the coagulant may be selected from the group consisting of: calcium sulfate; magnesium chloride; calcium chloride; glucono delta-lactone (GDL); acetic acid; citric acid; papain; an alkaline protease; a neutral protease; and mixtures thereof.

As will be appreciated by one of skill in the art, the conditions for the preparation of the sunflower, flax, camelina or hemp meal tofu-like product may be varied to produce different results, specifically, different textures and firmness for the end product. For example, mixtures of the coagulants and different quantities of the coagulants, both individually and relative to one another may be used.

It is noted that the selection of specific coagulants for specific nutritional benefits is well known within the tofu industry. Similar coagulant selections may be made for the tofu-like sunflower, flax, camelina or hemp meal product of the invention. Specifically, calcium sulfate or calcium chloride may be used to produce a tofu-like product that is high in calcium whereas magnesium chloride may be used to produce a tofu-like product that is high in magnesium.

As discussed below, the coagulant may be added at 0.5-5.0% (v/v) of the heated sunflower, flax, camelina and hemp milk.

As discussed below, the temperature to which the sunflower, flax, camelina or hemp milk is heated and the temperature at which the coagulant is added may depend on the coagulant selected. For example, calcium sulfate may be added at a temperature of 85-90° C. and the mixture mixed at a temperature of 85° C.; a combination of calcium sulfate and GDL may be added at a temperature of 80° C. and the mixture mixed at a temperature of 80° C.; or GDL may be added at a temperature of 75-80° C. and the mixture mixed at a temperature of 75° c. Suitable temperatures for other coagulants and coagulant mixtures may be determined by following the methods described herein.

For example, as discussed below, a combination of calcium sulfate and GDL produced an end product with a texture similar to silken tofu. Other firmness and textures can be obtained by varying the parameters discussed herein.

The invention will now be further illustrated by way of examples; however, the invention is not necessarily limited to the examples.

### Example 1: Sunflower, Flax, Camelina and Hemp Seed and Presscake

The composition of sunflower, flax, camelina, and hemp seeds are provided in Table 1 below. As will be apparent to one of skill in the art, the methods described herein are not specific to any one particular variety and may be used with any sunflower, flax, camelina and hemp variety.

TABLE 1
Proximate composition of sunflower, flax,
camelina and hemp seed and press cake

| | | sunflower | flax | camelina | hemp |
|---|---|---|---|---|---|
| Crude protein (% DM) | seed | 16.6 | 23.7 | NA | 23.9 |
| Crude fibre (% DM) | seed | 17.2 | 10.4 | NA | 16.5 |
| Energy (cal/100 g) | seed | 28.7 | 27.1 | NA | 26.2 |

For sunflower, tests were performed using de-hulled seeds. Sunflower seeds with hulls would be expected to give similar results since the hulls are comprised of resilient, fibrous, non-soluble material which would be removed by the sieving process

Sunflower, flax, camelina, and hemp press cakes were obtained from commercial facilities, using conventional methods. Filter cake is the non-soluble residue that remains on top of the filter; milk is the soluble portion that passes through the filter.

Different processing conditions (seed to water ratio, soaking time) may impact the properties of the resulting milk, for example protein concentration. The effect of these processing conditions on the protein content of milk from sunflower press cake is listed below. The preferred embodiment refers to the processing conditions which maximize protein yield.

TABLE 2
Protein Concentration in extracted sunflower press cake milk

| Seed to Water Ratio | Soaking time (h) | Protein (%) |
|---|---|---|
| 1:10 | 0 | 0.688 |
| 1:10 | 6 | 0.625 |
| 1:10 | 20 | 0.875 |
| 1:10 | 24 | 1.063 |
| 1:10 | 48 | 1.000 |
| 1:10 | 72 | 1.125 |
| 1:5 | 0 | 2.063 |
| 1:5 | 20 | 1.563 |

Given the similar properties of flax, camelina and hemp meals to sunflower meal relative to soybean meal (high fiber, low protein content, high protein solubility), it is expected that these meals would behave in similar manner to sunflower meals under the conditions listed above.

### Example 2: Production of Sunflower Tofu

Grinding and sieving was carried out to reduce amount of non soluble fragments including fibre prior to working with the press cake. It was further ground to pass through a 0.50 mm sieve. As the non-soluble particles tended to be larger, as discussed above, non-soluble particles were removed by the sieving process prior to the initial soak.

Approximately 15% of the press cake was removed by this sieving step in this trial.

### Milk Protein Extraction

The ground press cake was then soaked in certain amount of water for approximately 16 hours. A range of press cake to water ratios were evaluated. As discussed above, a ratio of press cake to water of between 10:1 to 4:1 is suitable; however, a ratio of 5:1 was used for those products that were evaluated. The mixture was filtered through a tea towel lined with two layers of cheesecloth to obtain sunflower milk concentrate.

### Tofu Procedure

The sunflower milk was slowly heated with gentle agitation to between 90° and 95° C. This induces protein unfolding. Heating was performed for 15-30 minutes in a generic heating vessel (i.e.: pot; steam kettle, etc.). Gentle agitation was performed by submersible paddle mixer set at 20 rpm, or equivalent.

It was then removed from the heat. Coagulant, dissolved in water at a ratio of 5 parts water to 1 part coagulant and a temperature appropriate for the coagulant, is added to induce coagulation of proteins. The mixture was then stirred gently for 30 seconds at the appropriate temperature (Table 3).

Gentle agitation keeps the soluble protein in solution; however, too much agitation produces a froth or foam which will reduce yield as will no agitation (due to precipitation).

Once the coagulant was incorporated into the mixture, it was left to set at room temperature for 30 minutes and then transferred to refrigerator and set for an additional 1.5 to 3 hours, at 4° C.

The resulting coagulum was drained through 3-4 layers of cheesecloth for 2 to 3 hours to produce a curd. The curd, wrapped in two layers of cheesecloth, was transferred to a mold and pressed overnight in refrigerator. Press time was extended to 20 hours to create firmer texture.

TABLE 3
Addition and mixing temperatures for coagulants
used in sunflower tofu prototypes

| | Addition Temperature | Mixing Temperature |
|---|---|---|
| Coagulant | (° C.) | (° C.) |
| CaSO₄ | 85-90 | 85 |
| CaSO₄ + GDL | 80 | 80 |
| GDL | 75-80 | 75 |

Evaluation of Texture and Color of Sunflower Tofu Obtained with Different Coagulants and Different Levels of Coagulant

Texture was analyzed with a TA-XT Plus texture Analyzer (Texture Technologies, Hamilton Mass.) and associated software. A penetration system with a 126.45 mm2 uniaxial compression ball, starting at a distance of 7.00 mm from the sample and compressing at a rate of 0.10 mm per second was used. Samples were held at refrigerated temperatures until tested to maintain consistent results. The maximum applied force (firmness) and stress to strain ratio of elastic modulus (elasticity) were evaluated. Tests were performed on full size samples in triplicate.

TABLE 4
Texture analysis of sunflower tofu prototype samples
in comparison to commercial soybean controls.

| | Texture Analyzer | | | | |
|---|---|---|---|---|---|
| | | Gradient | standard | | |
| Sample | sample | (g/sec) | deviation | force(g) | |
| Soft-tofu | Average | 1.89 | 0.37 | 75.433 | 0.049 |
| Extra firm | Average | 13.2 | 2.56 | 545.216 | 15.66 |
| 0.5% CaSO4 | Average | 1.5 | 0.27 | 30.692 | 3.92 |
| 1.5% CaSO4 | Average | 1.38 | 0.33 | 31.01 | 6.0 |
| 3% CaSO4 | Average | 1.21 | 0.17 | 31.52 | 2.05 |
| 5% CaSO4 | Average | 1.56 | 0.38 | 33.48 | 4.37 |
| 1.5% CaSO4 | Average | 2.32 | 1.91 | 44.09 | 5.29 |
| 0.5% GDL | Average | 2.09 | 1.35 | 46.77 | 8.06 |
| 1.0% GDL | Average | 1.70 | 0.12 | 54.50 | 1.70 |
| 1.0% GDL | Average | 1.95 | 0.61 | 54.29 | 30.41 |
| 0.75% GDL − | Average | 1.44 | 0.45 | 30.66 | 14.53 |
| 1.5% CaSO4 | | | | | |

### Color Analysis

The colour of the sunflower, flax, camelina and hemp tofu was measured using a Minolta cm-3500d spectrophotometer with Spectramagic nx software. CIE lightness (L*), yellow-blue (a*) and red-green (b*) values were determined in triplicate. Results of these analyses are summarized in Table 5.

TABLE 5
Summarized results of sunflower tofu color
determination using CIE L*a*b* parameters

Hunterlab Colorimeter ^{a}

| Sample | L* | a* | b* |
|---|---|---|---|
| White Std | 93.9 | −1 | 0.1 |
| White Std | 93.8 | 0 | 0.1 |
| Extra Firm Commercial | 78.4 | 0.3 | 19.95 |
| Soy Tofu | | | |
| Soft Commercial Soy | 82.75 | −1.45 | 16.15 |
| Tofu | | | |
| 0.5% CaSO4 | 73.15 | 0.5 | 13.65 |
| 1.5% CaSO4 | 80.6 | −0.15 | 12.05 |
| 3% CaSO4 | 80.9 | 0.6 | 13.75 |
| 5% CaSO4 | 86.4 | 0.8 | 10.15 |
| 1.5% CaSO4 + 1.5% GDL | 80 | 0.55 | 11.5 |
| 0.5% GDL | 67 | 0.45 | 12.45 |
| 1.0% GDL | 80.65 | 0 | 10.35 |
| 1.5% GDL | 80.7 | 0 | 10.4875 |

^{a} All samples at 5:1 water to press cake ratio

Texture measurements indicated that it was possible to create a sunflower, flax, camelina or hemp tofu with a texture similar to that seen for a commercial soft (or silken) tofu. 1.0% GDL provided texture values closer to the commercial product. Firmer and more elastic gels could be obtain with CaSO4, but even with levels of 5% CaSO4 both firmness and elasticity were considerably lower than that seem for the hard commercial soy tofu.

The colour of the sunflower tofu was noticeably different from the soy tofu.

### Impact of Milk Coagulants on Sunflower Tofu Yield

Food grade Calcium Sulfate Anhydrous (CaSO4) and Glucono delta-Lactone (GDL) were purchased from Spectrum Laboratory Products in Gardena Calif.

Acceptable yield of sunflower tofu can be obtained using a variety of coagulants at different concentrations applied to milk produced under different conditions (meal to water ratio, soaking time). The preferred embodiment refers to the set of conditions which maximize tofu yield

TABLE 6
Tofu yield due to the use of different concentration of milk coagulants

| Meal:Water | Soaking | Coagulants | | Pressing | Final | Yield |
|---|---|---|---|---|---|---|
| Ratio | time (h) | Type | w/v % | time (h) | weight | (%)* |
| 1:10 | 22 h 20 min | CaSO₄ | 1.5 | 19 | 30.5 g | 6.10 |
| 1:5 | 22 h 20 min | CaSO₄ | 3 | 70 | 72.3 g | 14.46 |
| 1:10 | 19 h | GDL | 1.5 | 24 | 32.9 g | 6.58 |
| 1:10 | 20 h | GDL | 3 | 24 | 29.4 g | 5.88 |
| 1:5 | 20 h | GDL | 3 | 24 | 64.4 g | 12.88 |
| 1:5 | 20 h | GDL | 3 | 24 | 68.5 g | 13.70 |
| 1:5 | 0 | CaSO₄ + | 1.5 + 1.5 | 24 | 61.8 g | 12.36 |
| | | GDL | | | | |
| 1:5 | 0 | GDL | 3 | 24 | 70.3 g | 14.06 |
| 1:5 | 0 | CaSO₄ + | 0.75 + 0.75 | 24 | 15.3 g | 3.06 |
| | | GDL | | | | |
| 1:5 | 0 | CaSO4 | 3 | 24 | 70.6 g | 14.12 |
| 1:5 | 0 | GDL | 1.5 | 24 | 39.5 g | 7.90 |
| 1:5 | 0 | GDL | 1.5 | 24 | 60.0 g | 12.00 |
| 1:5 | 0 | GDL | 3 | 24 | 55.5 g | 11.10 |
| 1:10 | 20 h | CaSO₄ | 1.5 | 24 | 27.8 g | 5.56 |

*Tofu yield was determined based on a wet matter basis using 500 mL of milk for each cake

Given the similar properties of flax, camelina and hemp meals to sunflower meal relative to soybean meal (high fiber, low protein content, high protein solubility), it is expected that these meals would behave in similar manner to sunflower meals under the conditions listed above.

### Example 3: Production of Flax Tofu

Grinding and sieving is performed to reduce the amount of non soluble fragments including fibre prior to working with the press cake. It is further ground to pass through a 0.50 mm sieve. As the non-soluble particles tended to be larger, as discussed above, non-soluble particles are removed by the sieving process prior to the initial soak. Approximately 15% of the press cake is removed by this sieving step in this trial.

### Milk Protein Extraction

The ground press cake is then soaked in certain amount of water for approximately 16 hours. A range of press cake to water ratios is evaluated. As discussed above, a ratio of press cake to water of between 10:1 to 4:1 is suitable; however, a ratio of 5:1 is used for those products that are evaluated. The mixture is filtered through a tea towel lined with two layers of cheesecloth to obtain flax milk concentrate.

### Tofu Procedure

The flax milk is slowly heated with gentle agitation to between 90° and 95° C. This induces protein unfolding.

It was then removed from the heat. Coagulant, dissolved in water at a ratio of 5 parts water to 1 part coagulant and a temperature appropriate for the coagulant (Table 7), is added to induce coagulation of proteins. The mixture was then stirred gently for 30 seconds at the appropriate temperature (Table 7).

Gentle agitation keeps the soluble protein in solution; however, too much agitation produces a froth or foam which will reduce yield as will no agitation (due to precipitation).

Once the coagulant is incorporated into the mixture, it is left to set at room temperature for 30 minutes and then transferred to refrigerator and set for an additional 1.5 hours.

The resulting coagulum is drained through 3-4 layers of cheesecloth for 2 to 3 hours to produce a curd. The curd, wrapped in two layers of cheesecloth, is transferred to a mold and pressed overnight in refrigerator. Press time is extended to 20 hours to create firmer texture.

TABLE 7
Addition and mixing temperatures for coagulants
used in flax tofu prototypes

| | Addition Temperature | Mixing Temperature |
|---|---|---|
| Coagulant | (° C.) | (° C.) |
| CaSO₄ | 85-90 | 85 |
| CaSO₄ + GDL | 80 | 80 |
| GDL | 75-80 | 75 |

### Texture Analysis

Texture is analyzed with a TA-XT Plus texture Analyzer (Texture Technologies, Hamilton Mass.) and associated software. A penetration system with a 126.45 mm2 uniaxial compression ball, starting at a distance of 7.00 mm from the sample and compressing at a rate of 0.10 mm per second is used. Samples are held at refrigerated temperatures until tested to maintain consistent results. The maximum applied force (firmness) and stress to strain ratio of elastic modulus (elasticity) are evaluated. Tests are performed on full size samples in triplicate.

### Color Analysis

The colour of the flax tofu is measured using a Minolta cm-3500d spectrophotometer with Spectramagic nx software. CIE lightness (L*), yellow-blue (a*) and red-green (b*) values are determined in triplicate.

Texture measurements indicate that it is possible to create a flax tofu with a texture similar to that seen for a commercial soft (or silken) tofu. 1.0% GDL provided texture values closer to the commercial product. Firmer and more elastic gels could be obtain with CaSO4, but even with levels of 5% CaSO4 both firmness and elasticity are considerably lower than that seem for the hard commercial soy tofu.

### Example 4: Production of Camelina Tofu

Grinding and sieving is performed to reduce amount of non soluble fragments including fibre prior to working with the press cake. It is further ground to pass through a 0.50 mm sieve. As the non-soluble particles tended to be larger, as discussed above, non-soluble particles are removed by the sieving process prior to the initial soak. Approximately 15% of the press cake is removed by this sieving step in this trial.

### Milk Protein Extraction

The ground press cake is then soaked in certain amount of water for approximately 16 hours. A range of press cake to water ratios is evaluated. As discussed above, a ratio of press cake to water of between 10:1 to 4:1 is suitable; however, a ratio of 5:1 is used for those products that are evaluated. The mixture is filtered through a tea towel lined with two layers of cheesecloth to obtain camelina milk concentrate.

### Tofu Procedure

The camelina milk is slowly heated with gentle agitation to between 90° and 95° C. This induces protein unfolding.

It was then removed from the heat. Coagulant, dissolved in water at a ratio of 5 parts water to 1 part coagulant and a temperature appropriate for the coagulant (Table 8), is added to induce coagulation of proteins. The mixture was then stirred gently for 30 seconds at the appropriate temperature (Table 8).

Gentle agitation keeps the soluble protein in solution; however, too much agitation produces a froth or foam which will reduce yield as will no agitation (due to precipitation).

Once the coagulant is incorporated into the mixture, it is left to set at room temperature for 30 minutes and then transferred to refrigerator and set for an additional 1.5 hours.

The resulting coagulum is drained through 3-4 layers of cheesecloth for 2 to 3 hours to produce a curd. The curd, wrapped in two layers of cheesecloth, is transferred to a mold and pressed overnight in refrigerator. Press time is extended to 20 hours to create firmer texture.

TABLE 8
Addition and mixing temperatures for coagulants
used in camelina tofu prototypes

| | Addition Temperature | Mixing Temperature |
|---|---|---|
| Coagulant | (° C.) | (° C.) |
| CaSO₄ | 85-90 | 85 |
| CaSO₄ + GDL | 80 | 80 |
| GDL | 75-80 | 75 |

### Texture Analysis

Texture is analyzed with a TA-XT Plus texture Analyzer (Texture Technologies, Hamilton Mass.) and associated software. A penetration system with a 126.45 mm2 uniaxial compression ball, starting at a distance of 7.00 mm from the sample and compressing at a rate of 0.10 mm per second is used. Samples are held at refrigerated temperatures until tested to maintain consistent results. The maximum applied force (firmness) and stress to strain ratio of elastic modulus (elasticity) are evaluated. Tests are performed on full size samples in triplicate.

### Color Analysis

The colour of the camelina tofu is measured using a Minolta cm-3500d spectrophotometer with Spectramagic nx software. CIE lightness (L*), yellow-blue (a*) and red-green (b*) values are determined in triplicate.

Texture measurements indicate that it is possible to create a camelina tofu with a texture similar to that seen for a commercial soft (or silken) tofu. 1.0% GDL provided texture values closer to the commercial product. Firmer and more elastic gels could be obtain with CaSO4, but even with levels of 5% CaSO4 both firmness and elasticity are considerably lower than that seem for the hard commercial soy tofu.

### Example 5: Production of Hemp Seed Tofu

Grinding and sieving is performed to reduce amount of non soluble fragments including fibre prior to working with the press cake. It is further ground to pass through a 0.50 mm sieve. As the non-soluble particles tended to be larger, as discussed above, non-soluble particles are removed by the sieving process prior to the initial soak. Approximately 15% of the press cake is removed by this sieving step in this trial.

### Milk Protein Extraction

The ground press cake is then soaked in certain amount of water for approximately 16 hours. A range of press cake to water ratios is evaluated. As discussed above, a ratio of press cake to water of between 10:1 to 4:1 is suitable; however, a ratio of 5:1 is used for those products that are evaluated. The mixture is filtered through a tea towel lined with two layers of cheesecloth to obtain hemp seed milk concentrate.

### Tofu Procedure

The hemp seed milk is slowly heated with gentle agitation to between 90° and 95° C. This induces protein unfolding.

It was then removed from the heat. Coagulant, dissolved in water at a ratio of 5 parts water to 1 part coagulant and a temperature appropriate for the coagulant (Table 9), is added to induce coagulation of proteins. The mixture was then stirred gently for 30 seconds at the appropriate temperature (Table 9).

Gentle agitation keeps the soluble protein in solution; however, too much agitation produces a froth or foam which will reduce yield as will no agitation (due to precipitation).

Once the coagulant is incorporated into the mixture, it is left to set at room temperature for 30 minutes and then transferred to refrigerator and set for an additional 1.5 hours.

The resulting coagulum is drained through 3-4 layers of cheesecloth for 2 to 3 hours to produce a curd. The curd, wrapped in two layers of cheesecloth, is transferred to a mold and pressed overnight in refrigerator. Press time is extended to 20 hours to create firmer texture.

TABLE 9
Addition and mixing temperatures for coagulants
used in hemp seed tofu prototypes

| | Addition Temperature | Mixing Temperature |
|---|---|---|
| Coagulant | (° C.) | (° C.) |
| CaSO₄ | 85-90 | 85 |
| CaSO₄ + GDL | 80 | 80 |
| GDL | 75-80 | 75 |

### Texture Analysis

Texture is analyzed with a TA-XT Plus texture Analyzer (Texture Technologies, Hamilton Mass.) and associated software. A penetration system with a 126.45 mm2 uniaxial compression ball, starting at a distance of 7.00 mm from the sample and compressing at a rate of 0.10 mm per second is used. Samples are held at refrigerated temperatures until tested to maintain consistent results. The maximum applied force (firmness) and stress to strain ratio of elastic modulus (elasticity) are evaluated. Tests are performed on full size samples in triplicate.

### Color Analysis

The colour of the hemp seed tofu is measured using a Minolta cm-3500d spectrophotometer with Spectramagic nx software. CIE lightness (L*), yellow-blue (a*) and red-green (b*) values are determined in triplicate.

Texture measurements indicate that it is possible to create a hemp seed tofu with a texture similar to that seen for a commercial soft (or silken) tofu. 1.0% GDL provided texture values closer to the commercial product. Firmer and more elastic gels could be obtain with CaSO4, but even with levels of 5% CaSO4 both firmness and elasticity are considerably lower than that seem for the hard commercial soy tofu.

The scope of the claims should not be limited by the preferred embodiments set forth in the examples, but should be given the broadest interpretation consistent with the description as a whole.

We claim:

1. A method of making a tofu-like curd comprising:
a) removing non-soluble fragments from ground meal cake;
b) soaking the ground meal cake in water for a period of time to produce a soaked meal cake;
c) filtering the soaked meal cake, thereby isolating a milk concentrate;
d) heating the milk concentrate while agitating the milk concentrate;
e) adding a coagulant to the heated milk concentrate to form a mixture;
f) cooling the mixture;
g) removing liquid from the mixture, thereby producing curd;
wherein the ground meal cake is selected from one or more of sunflower, flax, camelina and hemp seed ground meal cake.

2. The method according to claim 1 wherein the ground meal cake is soaked for 6-24 hours.

3. The method according to claim 1 wherein the ground meal cake and the water are mixed a ratio from 10:1 to 4:1.

4. The method according to claim 3 wherein the ground meal cake and the water are mixed a ratio of about 5:1.

5. The method according to claim 1 wherein the coagulant is selected from the group consisting of: calcium sulfate; magnesium chloride; magnesium sulfate (MgSO₄), calcium chloride; glucono delta-lactone (GDL); acetic acid; citric acid; papain; vinegar, an alkaline protease; a neutral protease; and mixtures thereof.

6. The method according to claim 1 wherein the coagulant is added at between 0.5% to 5.0% (v/v).

7. The method as claimed in claim 1, further comprising, before the removing non-soluble fragments, grinding meal cake to produce ground meal cake.

8. The method as claimed in claim 1, wherein the removing non-soluble fragments is carried out by sieving the ground meal cake.

9. The method as claimed in claim 8, wherein the sieving is done using about a 500 μm to 1 mm sieve.

10. The method as claimed in claim 9, wherein the sieving is done using about a 0.5 mm sieve.

11. The method as claimed in claim 1, further comprising pressing curd into a tofu-like product.

12. The method according to claim 1 wherein the milk concentrate is heated to a temperature between 75-100° C.

13. The method as claimed in claim 1, wherein the milk concentrate is heated to a temperature of about 90-95 C.

14. The method as claimed in claim 13, wherein the cooling is to a temperature of about 75-90 C.

15. The method as claimed in claim 1, wherein the cooling is performed at room temperate for about 10-60 minutes, then at −4° C. to 10° C. for about 1-12 hours.

16. The method as claimed in claim 1, wherein the cooling is performed at room temperate for about 30 minutes, then at about 5° C. for about 1.5 hours.

17. The method as claimed in claim 5, wherein the coagulant is glucono delta-lactone (GDL).

18. The method according to claim 1, wherein the steps are performed sequentially in the order presented.

19. A tofu like food product obtained by the method of claim 1.

20. A protein milk food product obtained by:
a) grinding a quantity of meal cake to produce ground meal cake;
b) passing the ground meal cake through sieve, thereby removing non-soluble fragments from the ground meal cake;
c) soaking the ground meal cake in water for a period of time to produce a soaked meal cake; and
d) filtering the soaked ground meal cake, thereby isolating a milk concentrate.
